(19) United States
(12) Patent Application Publication
(10) Pub. No.: US 2017/0289242 A1
(43) Pub. Date: Oct. 5, 2017

(54) TECHNOLOGIES FOR DYNAMIC WORK QUEUE MANAGEMENT

(71) Applicants: David Keppel, Mountain View, CA (US); Ulf R. Hanebutte, Gig Harbor, WA (US); Mario Flajslik, Hudson, MA (US); James Dinan, Hudson, MA (US)

(72) Inventors: David Keppel, Mountain View, CA (US); Ulf R. Hanebutte, Gig Harbor, WA (US); Mario Flajslik, Hudson, MA (US); James Dinan, Hudson, MA (US)

(21) Appl. No.: 15/087,536

(22) Filed: Mar. 31, 2016

(51) Int. Cl. H04L 29/08

(52) U.S. Cl. CPC H04L 67/1008

(57) ABSTRACT

Technologies for dynamic work queue management include a producer computing device communicatively coupled to a consumer computing device. The consumer computing device is configured to transmit a pop request (e.g., a one-sided pull request) that includes consumption constraints indicating an amount of work (e.g., a range of acceptable fraction of work elements to return from a work queue of the producer computing device) to pull from the producer computing device. The producer computing device is configured to determine whether the pop request can be satisfied and generate a response that includes an indication of the result of the determination and one or more producer metrics usable by the consumer computing device to determine a subsequent action to be performed by the consumer computing device upon receipt of the response message. Other embodiments are described and claimed herein.

### GOVERNMENT RIGHTS CLAUSE

This invention was made with Government support under contract number H98230-13-D-0124 awarded by the Department of Defense. The Government has certain rights in this invention.

### BACKGROUND

Demands by individuals, researchers, and enterprise for increased compute performance and storage capacity of computing devices have resulted in various computing technologies having been developed to address those demands. For example, compute intensive applications, such as enterprise cloud-based applications (e.g., software as a service (SaaS) applications), data mining applications, data-driven modeling applications, scientific computation problem solving applications, etc., typically rely on complex, large-scale computing environments, such as high-performance computing (HPC) environments and cloud computing environments, to execute the compute intensive applications, as well as store the voluminous amount of data. Such large-scale computing environments can include tens of thousands of multi-processor/multi-core computing devices connected via high-speed interconnects.

Generally, such applications require ongoing, dynamic load balancing to achieve scalable performance and availability due to the unpredictable work volume produced at any given time. Accordingly, various load balancing technologies have been developed (e.g., domain name system (DNS) load balancing, cloud load balancing, graph partitioning, master-worker balancing, etc.) to efficiently allocate dynamically allocable workloads across the various computing devices. One such load balancing approach typically used in HPC environments is commonly referred to as work stealing, in which computing devices produce work, which is then added to a local queue. In turn, other computing devices read, or “steal,” work from the producer's queue in order to consume or otherwise perform the stolen work.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for dynamic work queue management that includes a producer computing device communicatively coupled to multiple consumer computing devices;

FIG. 2 is a simplified block diagram of at least one embodiment of the producer computing device of the system of FIG. 1;

FIG. 3 is a simplified block diagram of at least one embodiment of the consumer computing device of the system of FIG. 1;

FIG. 4 is a simplified block diagram of at least one embodiment of an environment of the consumer computing device of FIGS. 1 and 3;

FIG. 5 is a simplified block diagram of at least one embodiment of an environment of the producer computing device of FIGS. 1 and 2;

FIG. 6 is a simplified flow diagram of at least one embodiment for requesting work from the producer computing device of FIGS. 1 and 2 that may be executed by the consumer computing device of FIGS. 1 and 3; and

FIGS. 7 and 8 is a simplified flow diagram of at least one embodiment for processing a pop request from the consumer computing device of FIGS. 1 and 3 that may be executed by the producer computing device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

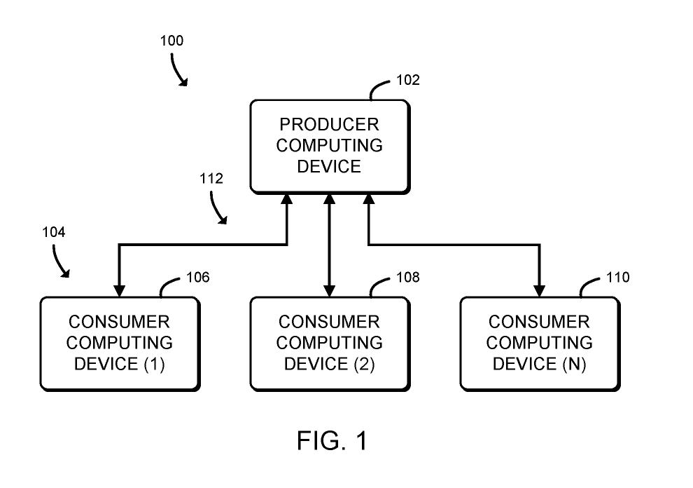

Referring now to FIG. 1, in an illustrative embodiment, a system 100 for dynamic work queue management includes a producer computing device 102 communicatively coupled to multiple consumer computing devices 104 of a high-performance computing (HPC) fabric via interconnects 112. In use, the producer computing device 102 generates work (e.g., data, tasks, etc.), which the producer computing device 102 adds to a local queue (e.g., a work queue). The consumer computing devices 104 requests to pull at least a portion of the generated work (e.g., work elements of the work queue) from the producer computing device 102. For example, an application presently executing on a producer computing device 102 may enqueue work elements into the work queue local to the producer computing device 102 and an application presently executing on a consumer computing device 104 may request to pull some of the enqueued work elements. The producer computing device 102 may then dequeue and transmit at least a portion of the requested work elements from the work queue to the requesting consumer computing device 104, which may then consume the received work elements.

However, unlike present technologies in which the consumer computing devices 104 only request a fixed number of elements based on a prior probing of the producer computing device 102 (e.g., in a load balancing process commonly referred to as work stealing), the consumer computing devices 104 are configured to request a range of work elements to pull from the available work queue of the producer computing device 102. To do so, the consumer computing devices 104 are configured to generate a pop request that includes a maximum and minimum number of work elements (e.g., an upper and lower bound) that are acceptable to be pulled from the available work queue of the producer computing device 102. In some embodiments, the consumer computing devices 104 are configured to generate a pop request that includes additional information, such as a fraction usable by the producer computing device 102 to determine a portion of the available work elements to return. For example, the pop request may be a one-sided pull initiated from one of the consumer computing devices 104.

The producer computing device 102, in response to having received the pop request, determines a number of work elements from the work queue to return to the consumer computing device 104 from which the pop request was received. In other words, the producer computing device 102 is configured to determine a variable number of work elements to provide to the respective consumer computing devices 104. To do so, the producer computing device 102 is configured to first interpret the range and/or additional information to determine whether the pop request can be satisfied. It should be appreciated that a work queue manager, such as a work stealing scheduler of the producer computing device 102, may be used by the producer computing device 102 to perform the work queue management (e.g., the enqueuing and dequeuing of work elements of the work queue).

Based on the received range and/or additional information, the producer computing device 102 may return a number of work elements in compliance with the request and/or an indication of the number of work elements to be returned in a response message. The producer computing device 102 may additionally include feedback information usable by the consumer computing devices 104 to make a well-informed decision on a subsequent action to be performed upon receipt of the response message. It should be appreciated that the number of work elements to be returned may be zero, an indication that the pop request failed. The subsequent actions to be performed by the consumer computing devices 104 upon receipt of the response message may include determining whether to resend the pop request (e.g., send the same or a modified pop request to the producer computing device), wait a duration of time before taking another action, or select a different producer computing device for which to send the same or a modified pop request.

It should be appreciated that while only a single producer computing device 102 is shown in the illustrative system 100, more than one producer computing device 102 may be communicatively coupled to one or more of the consumer computing devices 104. It should be further appreciated that while the illustrative computing devices are designated as either producer computing devices 102 or consumer computing devices 104 in the illustrative system 100, each computing device may be capable of acting as both a producer and a consumer in other embodiments. Additionally, it should be appreciated that there may be multiple producers and/or consumers on a single computing device, such as in embodiments that include multiple processors and/or one or more multi-core processor(s).

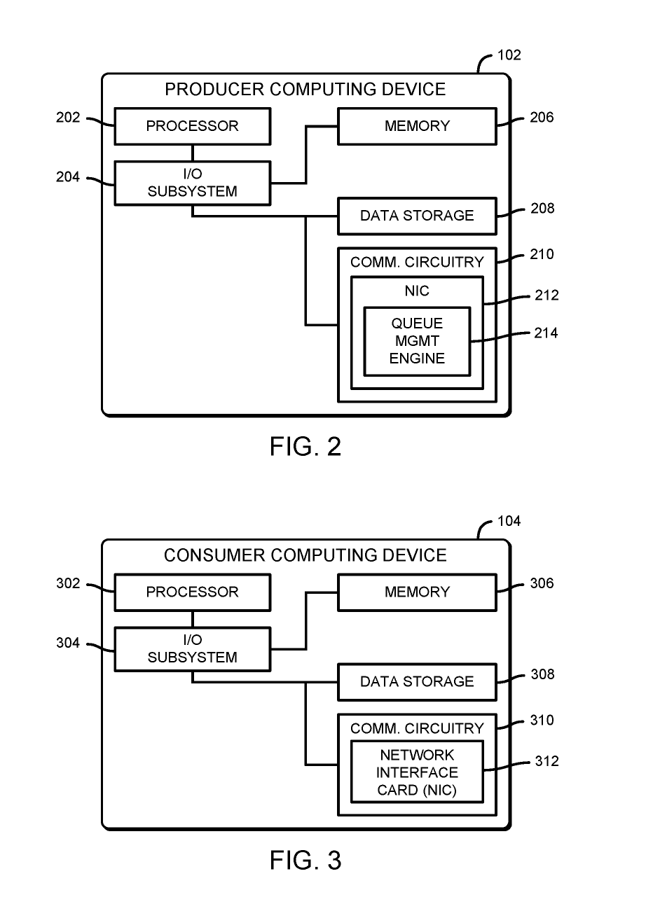

The producer computing device 102 may be embodied as any type of network traffic processing and/or forwarding device capable of performing the functions described herein, such as, without limitation, a server (e.g., stand-alone, rack-mounted, blade, etc.), a switch (e.g., rack-mounted, standalone, fully managed, partially managed, full-duplex, and/or half-duplex communication mode enabled, etc.), a network appliance (e.g., physical or virtual), a router, a web appliance, a distributed computing system, a processor-based system, and/or a multiprocessor system. As shown in FIG. 2, the illustrative producer computing device 102 includes a processor 202, an input/output (I/O) subsystem 204, a memory 206, a data storage device 208, and communication circuitry 210. Of course, in other embodiments, the producer computing device 102 may include other or additional components, such as those commonly found in a computing device (e.g., one or more peripheral devices). Further, in some embodiments, one or more of the illustrative components may be omitted from the producer computing device 102. Additionally, in some embodiments, one or more of the illustrative components may be incorporated in, or otherwise form a portion of, another component. For example, the memory 206, or portions thereof, may be incorporated in the processor 202, in some embodiments.

The processor 202 may be embodied as any type of processor capable of performing the functions described herein. For example, the processor 202 may be embodied as a single or multi-core processor(s), digital signal processor, microcontroller, or other processor or processing/controlling circuit. The memory 206 may be embodied as any type of volatile or non-volatile memory or data storage capable of performing the functions described herein. In operation, the memory 206 may store various data and software used during operation of the producer computing device 102, such as operating systems, applications, programs, libraries, and drivers.

The memory 206 is communicatively coupled to the processor 202 via the I/O subsystem 204, which may be embodied as circuitry and/or components to facilitate input/output operations with the processor 202, the memory 206, and other components of the producer computing device 102. For example, the I/O subsystem 204 may be embodied as, or otherwise include, memory controller hubs, input/output control hubs, firmware devices, communication links (e.g., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processor 202, the memory 206, and/or other components of the producer computing device 102, on a single integrated circuit chip.

The data storage device 208 may be embodied as any type of device or devices configured for short-term or long-term storage of data, such as memory devices and circuits, memory cards, hard disk drives, solid-state drives, or other data storage devices, for example. It should be appreciated that the data storage device 208 and/or the memory 206 (e.g., the computer-readable storage media) may store various types of data capable of being executed by a processor (e.g., the processor 202) of the producer computing device 102, including operating systems, applications, programs, libraries, drivers, instructions, etc.

The communication circuitry 210 may be embodied as any communication circuit, device, or collection thereof, capable of enabling communications between the producer computing device 102 and other computing devices (e.g., the consumer computing devices 104 either directly or via one or more network computing devices associated with the interconnects 112 described below, another computing device communicatively coupled to the HPC fabric, etc.). Accordingly, the communication circuitry 210 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication.

The illustrative communication circuitry 210 includes a network interface controller (NIC) 212, also commonly referred to as a host fabric interface (HFI) in such HPC fabrics. The NIC 212 may be embodied as one or more add-in-boards, daughtercards, network interface cards, controller chips, chipsets, or other devices that may be used by the producer computing device 102. For example, in some embodiments, the NIC 212 may be integrated with the processor 202, embodied as an expansion card coupled to the I/O subsystem 204 over an expansion bus (e.g., PCI Express), part of a SoC that includes one or more processors, or included on a multichip package that also contains one or more processors. Additionally or alternatively, in some embodiments, functionality of the NIC 212 may be integrated into one or more components of the producer computing device 102 at the board level, socket level, chip level, and/or other levels.

The illustrative NIC 212 includes a queue management engine 214 that may be embodied as any hardware, firmware, software, or combination thereof capable of performing the functions described herein, such as managing the work queues containing produced work elements. For example, in some embodiments, the queue management engine 214 may be embodied as limited-function high-speed hardware that is operable (e.g., using management software) to execute rule-based queue management decisions, which are described in further detail below. The queue management engine 214 is configured to manage optionally-ordered lists of items supporting local push and remote pop operations. In other words, the queue management engine 214 is configured to access the work queues in a first in first out (FIFO) or last in first out (LIFO) order, as well as manage the size of the produced work elements contained in the work queue. The queue management engine 214 is further configured to manage the receipt and processing of pop requests received from the various consumer computing devices 104.

Referring again to FIG. 1, the illustrative consumer computing devices 104 includes a first consumer computing device, designated as consumer computing device (1) 106, a second consumer computing device, designated as consumer computing device (2) 108, and a third consumer computing device, designated as consumer computing device (N) 110 (e.g., the “Nth” consumer computing device of the consumer computing devices 104, wherein “N” is a positive integer and designates one or more additional consumer computing devices 104). Similar to the producer computing device 102, each of the consumer computing devices 104 may be embodied as any type of computing device that is capable of performing the functions described herein, such as, without limitation, a server (e.g., stand-alone, rack-mounted, blade, etc.), a switch (e.g., rack-mounted, standalone, fully managed, partially managed, full-duplex, and/or half-duplex communication mode enabled, etc.), a network appliance (e.g., physical or virtual), a router, a web appliance, a distributed computing system, a processor-based system, and/or a multiprocessor system.

Accordingly, as shown in FIG. 3, an illustrative consumer computing device 104 include a processor 302, an I/O subsystem 304, a memory 306, a data storage device 308, and communication circuitry 310 that includes a NIC 312. As such, further descriptions of the like components are not repeated herein with the understanding that the description of the corresponding components provided above in regard to the illustrative producer computing device 102 of FIG. 2 applies equally to the corresponding components of the consumer computing device 104 of FIG. 3.

Referring again to FIG. 1, each of the interconnects 112 between the producer computing device 102 and the consumer computing devices 104 may be embodied as, or otherwise include, any type of computing device (e.g., interconnection switches, access switches, port extenders, etc.), switch management software, and/or data cables usable to provide a system of interconnects between the producer computing device 102 and the consumer computing devices 104, such as may be found in an HPC fabric (e.g., in a data center), to provide low-latency and high-bandwidth communication between any two points in the HPC fabric. In other words, the interconnects 112 are usable by the producer computing device 102 and the consumer computing devices 104 to transmit data (e.g., messages, work elements, etc.) therebetween.

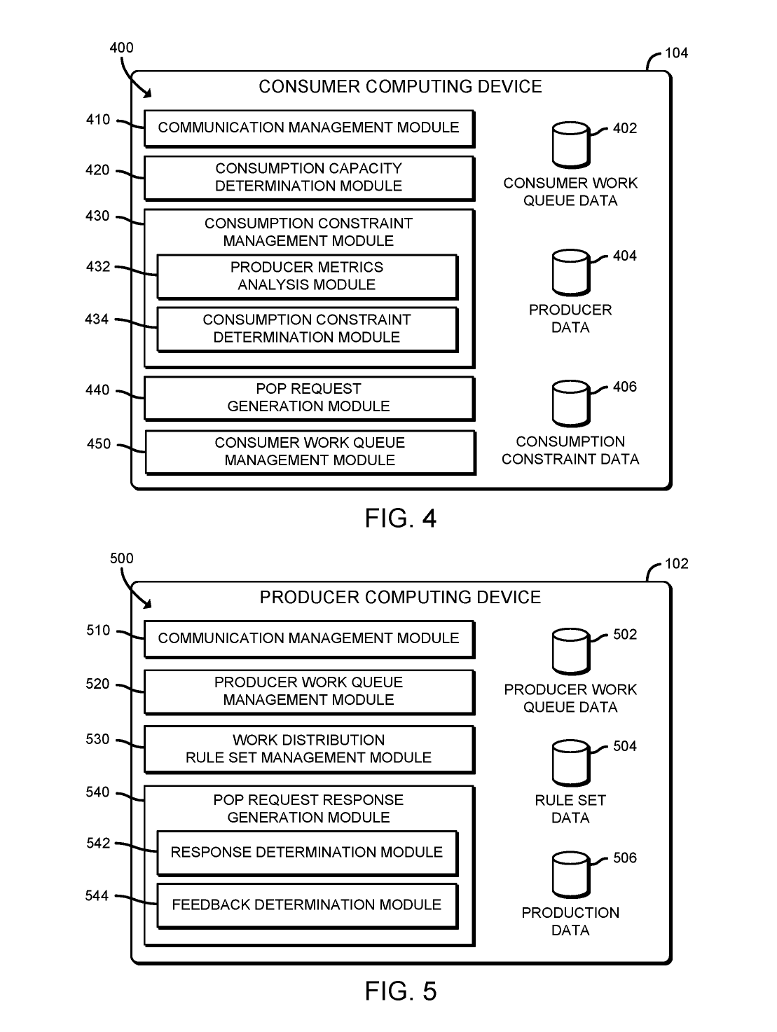

Referring now to FIG. 4, in an illustrative embodiment, a consumer computing device (e.g., one of the consumer computing devices 104 of FIG. 1) establishes an environment 400 during operation. The illustrative environment 400 includes a communication management module 410, a consumption capacity determination module 420, a consumption constraint management module 430, a pop request generation module 440, and a consumer work queue management module 450. The various modules of the environment 400 may be embodied as hardware, firmware, software, or a combination thereof. As such, in some embodiments, one or more of the modules of the environment 400 may be embodied as circuitry or collection of electrical devices (e.g., a communication management circuit 410, a consumption capacity determination circuit 420, a consumption constraint management circuit 430, a pop request generation circuit 440, a consumer work queue management circuit 450, etc.).

It should be appreciated that, in such embodiments, one or more of the communication management circuit 410, the consumption capacity determination circuit 420, the consumption constraint management circuit 430, and the pop request generation circuit 440 may form a portion of one or more of the processor 302, the I/O subsystem 304, the communication circuitry 310, and/or other components of the consumer computing device 104. Additionally, in some embodiments, one or more of the illustrative modules may form a portion of another module and/or one or more of the illustrative modules may be independent of one another. Further, in some embodiments, one or more of the modules of the environment 400 may be embodied as virtualized hardware components or emulated architecture, which may be established and maintained by the processor 302 or other components of the consumer computing device 104.

In the illustrative environment 400, the consumer computing device 104 further includes consumer work queue data 402, producer data 404, and consumption constraint data 406, each of which may be stored in the memory 306 and/or the data storage device 308 of the consumer computing device 104. Further, each of the consumer work queue data 402, the producer data 404, and/or the consumption constraint data 406 may be accessed by the various modules and/or sub-modules of the consumer computing device 104. It should be appreciated that the consumer computing device 104 may include additional and/or alternative components, sub-components, modules, sub-modules, and/or devices commonly found in a computing device, which are not illustrated in FIG. 4 for clarity of the description.

The communication management module 410, which may be embodied as hardware, firmware, software, virtualized hardware, emulated architecture, and/or a combination thereof as discussed above, is configured to facilitate inbound and outbound wired and/or wireless network communications (e.g., network traffic, network packets, network flows, etc.) to and from the consumer computing device 104. To do so, the communication management module 410 is configured to receive and process network packets from other computing devices (e.g., the producer computing device 102 and/or other computing device(s) communicatively coupled to the consumer computing device 104). Additionally, the communication management module 410 is configured to prepare and transmit network packets to another computing device (e.g., the producer computing device 102 and/or other computing device(s) communicatively coupled to the consumer computing device 104). Accordingly, in some embodiments, at least a portion of the functionality of the communication management module 410 may be performed by the communication circuitry 310 of the consumer computing device 104, or more specifically by a NIC 312 of the communication circuitry 310.

The consumption capacity determination module 420, which may be embodied as hardware, firmware, software, virtualized hardware, emulated architecture, and/or a combination thereof as discussed above, is configured to determine a consumption capacity for a work queue of the consumer computing device 104 (e.g., a consumer work queue). In other words, the consumption capacity determination module 420 is configured to determine how much work (e.g., a number of work elements) the consumer computing device 104 can consume, or otherwise request to be consumed. For example, the consumption capacity determination module 420 may be configured to determine the consumption capacity based on an actual capacity, which may be determined by subtracting a present consumption level of the consumer work queue (e.g., a present fullness of the consumer work queue) from a present size of the consumer work queue.

It should be appreciated that, in some embodiments, it is not desirable for the consumer work queue to be completely full. In other words, the consumption capacity determination module 420 may limit the number of work elements to request, or the consumption capacity, to an amount less than the actual capacity. In such embodiments, the consumption capacity determination module 420 may be configured to determine an effective capacity based on an acceptable level of fullness (e.g., a capacity threshold, a maximum fullness percentage, etc.) and the size of the consumer work queue. For example, the consumption capacity determination module 420 may be configured to multiply the present size of the consumer work queue by the maximum fullness percentage (e.g., 90%), such that the consumer work queue does not get completely filled upon a successful return of work elements of the producer work queue. Accordingly, in such embodiments, the consumption capacity determination module 420 may be configured to subtract the present consumption level from the effective capacity to determine the consumption capacity, rather than the present capacity. In some embodiments, such data related to the consumer work queue may be stored in the consumer work queue data 402.

The consumption constraint management module 430, which may be embodied as hardware, firmware, software, virtualized hardware, emulated architecture, and/or a combination thereof as discussed above, is configured to manage the consumption constraints defining acceptable limits on the number of work elements of the producer work queue that are to be requested (e.g., stolen or popped) from the producer computing device 102. The consumption constraints may include a size of the work elements to be returned, a number of work elements to request from the producer work queue, an acceptable range of work elements (e.g., an upper threshold of work elements of the producer work queue and a lower threshold of work elements of the producer work queue) to request from the producer work queue, and/or a fraction of available work elements of the producer work queue to receive. In some embodiments, the consumption constraints may be stored in the consumption constraint data 406. To manage the consumption constraints, the illustrative consumption constraint management module 430 includes a producer metrics analysis module 432 and a consumption constraint determination module 434.

It should be appreciated that each of the producer metrics analysis module 432 and the consumption constraint determination module 434 of the consumption constraint management module 430 may be separately embodied as hardware, firmware, software, virtualized hardware, emulated architecture, and/or a combination thereof. For example, the producer metrics analysis module 432 may be embodied as a hardware component, while the consumption constraint determination module 434 is embodied as a virtualized hardware component or as some other combination of hardware, firmware, software, virtualized hardware, emulated architecture, and/or a combination thereof.

The producer metrics analysis module 432 is configured to analyze producer metrics, described in detail below, received from the producer computing device 102. As described previously, it should be appreciated that, in some embodiments, there may be more than one producer computing device 102 and both the consumer computing devices 104 and the producer computing devices 102 may act as both consumer and producer. In such embodiments, the number of work elements available to be stolen tends to be balanced. Accordingly, the producer metrics may include producer metrics from multiple producer computing devices 102. As such, the producer metrics analysis module 432 may be configured to analyze multiple producer computing devices 102. In some embodiments, the producer metrics may be stored in the producer data.

The consumption constraint determination module 434 is configured to determine the consumer constraints. To do so, the consumption constraint determination module 434 may determine an initial set of constraints. It should be appreciated that the consumption constraints are a determined relative to the consumption capacity of the consumer work queue or the effective capacity of the consumer work queue, as may be determined by the consumption capacity determination module 420. For example, the consumption constraint determination module 434 may be configured to generate an upper bound (e.g., a value equal to the effective capacity), as well as a lower bound, such as may be determined based on a minimum number of work elements required to be returned from any one producer work queue. Additionally, the consumption constraint determination module 434 may be configured to tune or otherwise update one or more of the consumption constraints based on an analysis of the producer metrics received in response to previous pop requests, such as may be performed by the producer metrics analysis module 432.

In an illustrative example, a previous pop request may have been transmitted by the consumer computing device 104 that included a request for 1000 work elements (e.g., either requested 1000 work elements or indicated 1000 work elements was a lower bound, or acceptable minimum number of return work elements), for which the producer computing device 102 may have rejected, but also indicated that 500 work elements were available at the time the pop request was received. Accordingly, the consumption constraint determination module 434 may determine that reducing the requested number of work elements, or lower bound, to 500 may yield successful results in future pop requests.

In an illustrative example, in which the producer computing device 102 has insufficient data to satisfy the pop request, the consumer computing device 104 may try to request work from the producer computing device 102 again (e.g., after a predetermined amount of time has elapsed) or generate another pop request for another computing device from which the consumer computing device 104 can potentially pull work from. To do so, the producer metrics analysis module 432 analyzes one or more producer metrics from a failed message received from the producer computing device 102. The producer metrics may include any data usable by the consumer computing device 104 to make a decision on a subsequent action to take upon receipt of the failure message. For example, the subsequent action may include resending the same pop request, sending another pop request that includes modified consumption constraints, waiting a duration of time before taking another action, sending the pop request to another producer computing device, and/or sending the other pop request to another producer computing device. Based on the analysis, the consumption constraint determination module 434 may adjust one or more of the consumption constraints.

The pop request generation module 440, which may be embodied as hardware, firmware, software, virtualized hardware, emulated architecture, and/or a combination thereof as discussed above, is configured to generate a pop request for transmission to a producer computing device 102. As described previously, the pop request may be a one-sided pull initiated by one of the consumer computing devices 104. The pop request generation module 440 is configured to generate the pop request in response to having detected a condition related to the consumer work queue. For example, the pop request generation module 440 may be configured to generate the pop request in response to a determination that an amount of consumption capacity, such as may be determined by the consumption capacity determination module 420, is available.

Additionally or alternatively, the pop request generation module 440 may be configured to generate the pop request as a function of a request trigger threshold. For example, the pop request generation module 440 may be configured to initiate generation of the pop request in response to a determination that a present fullness level of the consumer work queue and/or a number of present work elements of the consumer work queue is detected below request trigger threshold. Accordingly, the pop request generation module 440 can initiate generation in response to having detected the consumer work queue being in a low work level state and base the amount of work to request on the determined consumption capacity. The pop request generation module 440 is further configured to generate a pop request that includes the consumption constraints, as well as identifying information of the producer computing device 102 for which the pop request is intended.

The consumer work queue management module 450, which may be embodied as hardware, firmware, software, virtualized hardware, emulated architecture, and/or a combination thereof as discussed above, is configured to manage the consumer work queue. In other words, the consumer work queue management module 450 is configured to manage the push and pop operations on the consumer work queue. For example, upon receipt of one or more work elements from a pop request, the consumer work queue management module 450 may be configured to push the received work element(s) into the consumer work queue.

Referring now to FIG. 5, in an illustrative embodiment, a producer computing device 102 establishes an environment 500 during operation. The illustrative environment 500 includes a communication management module 510, a producer work queue management module 520, a work distribution rule set management module 530, and a pop request response generation module 540. The various modules of the environment 500 may be embodied as hardware, firmware, software, or a combination thereof. As such, in some embodiments, one or more of the modules of the environment 500 may be embodied as circuitry or collection of electrical devices (e.g., a communication management circuit 510, a producer work queue management circuit 520, a work distribution rule set management circuit 530, a pop request response generation circuit 540, etc.).

It should be appreciated that, in such embodiments, one or more of the communication management circuit 510, the producer work queue management circuit 520, the work distribution rule set management circuit 530, and the pop request response generation circuit 540 may form a portion of one or more of the processor 202, the I/O subsystem 204, the communication circuitry 210 (e.g., the NIC 212 and/or the queue management engine 214), and/or other components of the producer computing device 102. Additionally, in some embodiments, one or more of the illustrative modules may form a portion of another module and/or one or more of the illustrative modules may be independent of one another. Further, in some embodiments, one or more of the modules of the environment 500 may be embodied as virtualized hardware components or emulated architecture, which may be established and maintained by the processor 202 or other components of the producer computing device 102.

In the illustrative environment 300, the producer computing device 102 further includes producer work queue data 502, rule set data 504, and production data 506, each of which may be stored in the memory 206 and/or the data storage device 208 of the producer computing device 102. Further, each of the producer work queue data 502, the rule set data 504, and/or the production data 506 may be accessed by the various modules and/or sub-modules of the producer computing device 102. It should be appreciated that the producer computing device 102 may include additional and/or alternative components, sub-components, modules, sub-modules, and/or devices commonly found in a computing device, which are not illustrated in FIG. 5 for clarity of the description.

The communication management module 510, which may be embodied as hardware, firmware, software, virtualized hardware, emulated architecture, and/or a combination thereof as discussed above, is configured to facilitate inbound and outbound wired and/or wireless network communications (e.g., network traffic, network packets, network flows, etc.) to and from the producer computing device 102. To do so, the communication management module 510 is configured to receive and process network packets from other computing devices (e.g., the consumer computing devices 104 and/or other computing device(s) communicatively coupled to the producer computing device 102). Additionally, the communication management module 510 is configured to prepare and transmit network packets to another computing device (e.g., the consumer computing devices 104 and/or other computing device(s) communicatively coupled to the producer computing device 102). Accordingly, in some embodiments, at least a portion of the functionality of the communication management module 510 may be performed by the communication circuitry 210 of the producer computing device 102, or more specifically by a NIC 212 of the communication circuitry 210.

The producer work queue management module 520, which may be embodied as hardware, firmware, software, virtualized hardware, emulated architecture, and/or a combination thereof as discussed above, is configured to manage the work queues of the producer computing device 102 (e.g., producer work queues). In other words, the producer work queue management module 520 is configured to facilitate push and pop operations for the producer work queues. As described previously, the producer work queues include work produced by the producer computing device 102 that is available for consumption (e.g., via a pop request) by one or more consumer computing devices 104. Accordingly, the producer work queue management module 520 is configured to push produced work into a producer work queue (e.g., enqueued produced work elements into the work queue) and pop the work elements from the producer work queue (e.g., the produced work dequeued from the work queue), such as may be performed upon a successful pop request.

In some embodiments, the producer work queue management module 520 may be configured to manage the work queues in a LIFO data structure. Alternatively, in some embodiments, the producer work queue management module 520 may be configured to manage the work queues in a FIFO data structure. In other words, the producer work queue management module 520 is configured to manage the producer work queues regardless of the data structure being employed (e.g., a stack or a queue) for the producer work queues. In such embodiments employing a FIFO structure, the producer work queue management module 520 may be configured to manage the FIFO structured producer work queue to support “wrap around” (e.g., a circular queue or ring buffer). Accordingly, in such embodiments, the producer work queue management module 520 may be configured to add work incrementally to the producer work queue, as long as space is available in the producer work queue or by replacing the oldest work element when the producer work queue is full. As a result, using a fixed allocation as a circular queue may significantly reduce memory management overheads for applications and/or runtimes.

In some embodiments, the producer work queue management module 520 may further support dynamically sized producer work queues. In other words, the producer work queue management module 520 may be configured to add or remove space allocated to the producer work queues as needed, such as may be based on the present number of work elements contained therein and the present number of work elements being produced for insertion into the producer work queues. It should be appreciated that, when a pop operation crosses a discontinuity in memory (e.g., a wrap-around point of a circular queue), the producer work queue management module 520 is configured to handle the operation transparently.

The producer work queue management module 520 is further configured to capture and store, or otherwise return upon request, data related to a present state of the producer work queues (e.g., present producer work queue data). The present producer work queue data may include a present queue size, an available queue size, a number of work elements presently in each queue, an insertion point, an index to a start of valid data in the queue (e.g., a head location), an index to an end of valid data in the queue (e.g., a tail location). In some embodiments, the present producer work queue data and/or any other data related to the producer work queues may be stored in the producer work queue data 502.

The work distribution rule set management module 530, which may be embodied as hardware, firmware, software, virtualized hardware, emulated architecture, and/or a combination thereof as discussed above, is configured to manage a work distribution rule set. The work distribution rule set includes one or more rules, or policies, usable by the producer computing device 102 to determine how to distribute available work from the producer work queues. For example, the work distribution rule set may include various minimum/maximum thresholds, such as a minimum work release threshold (e.g., a minimum total number of work elements to return per received pop request), a maximum work release threshold (e.g., a maximum total number of work elements to return per received pop request).

In some embodiments, the work distribution rule set management module 530 may be additionally configured to dynamically adjust the work distribution rule set, such as may be based on specific heuristics determinable from historical pop requests/distribution (e.g., historical rates of production/consumption). For example, the work distribution rule set may indicate that any received pop request gets at most a fraction of the available work elements in a particular producer work queue. Accordingly, in such an embodiment, the work distribution rule set management module 530 is configured to determine the minimum work release threshold dynamically based on a present number of available work elements in the producer work queue and the constraints provided in the received pop request. In some embodiments, the work distribution rule set may be stored in the rule set data 504. Additionally or alternatively, the heuristics and/or historical rate information may be stored in the production data 506.

The pop request response generation module 540, which may be embodied as hardware, firmware, software, virtualized hardware, emulated architecture, and/or a combination thereof as discussed above, is configured to generate a message in response to having received a pop request from one of the consumer computing devices 104. For example, upon having received a pop request that can be returned successfully, the pop request response generation module 540 is configured to generate a success message that includes the number of work elements from the producer work queue determined to be returned. Accordingly, the pop request response generation module 540 may be configured to request that the producer work queue management module 520 perform a pop operation on each of the work elements of the producer work queue to be returned, such that the popped work elements of the producer work queue can be inserted into one or more payloads associated with the success message. In other words, it should be appreciated that a response message that includes one or more requested work elements of the producer work queue is considered a success message. In another example, upon having received a pop request that cannot be returned successfully, the pop request response generation module 540 is configured to generate a failure message that includes feedback, as described below.

To generate the message in response to having received a pop request from one of the consumer computing devices 104, the illustrative pop request response generation module 540 includes a response determination module 542 and a feedback determination module 544. It should be appreciated that each of the response determination module 542 and the feedback determination module 544 of the pop request response generation module 540 may be separately embodied as hardware, firmware, software, virtualized hardware, emulated architecture, and/or a combination thereof. For example, the response determination module 542 may be embodied as a hardware component, while the feedback determination module 544 is embodied as a virtualized hardware component or as some other combination of hardware, firmware, software, virtualized hardware, emulated architecture, and/or a combination thereof.

The response determination module 542 is configured to determine an appropriate response to the received pop request. In other words, the response determination module 542 is configured to determine how many present work elements (e.g., none of the requested work elements, a portion of the requested work elements, all of the requested work elements, etc.) of work in a producer work queue to return to the consumer computing device 104 from which the pop request message was received. As described previously, the pop request may be a one-sided pull initiated by one of the consumer computing devices 104.

To determine the appropriate response to the received pop request, the response determination module 542 is configured to determine an amount of work (e.g., a number of work elements of the producer work queue) that is available to be stolen (e.g., an effective work availability), such as may be determined based on a number of work elements presently in a producer work queue and a present size of the producer work queue. In other words, the effective work availability sets a maximum an amount of work that may be stolen (e.g., an upper threshold). It should be appreciated that the effective work availability may be less than an actual amount of work in the producer work queue (e.g., an actual work availability) to promote fairness of the work distribution across the consumer computing devices 104.

In some embodiments, the response determination module 542 may be configured to determine the effective work availability based on a predetermined rule (e.g., one of the rules of the work distribution rule set maintained by the work distribution rule set management module 530 described above). For example, the rule may indicate an upper threshold (e.g., a maximum number of work elements of the producer work queue to return) and a lower threshold (e.g., a minimum number of work elements of the producer work queue to return). In some embodiments, the rule may specify a statically fixed value for the thresholds or a means by which to determine the thresholds. For example, the rule may indicate a fraction to apply to the actual work availability that limits the amount of work elements of the producer work queue to return (e.g., a dynamic upper threshold) to a fraction of the actual work availability. Additionally, in some embodiments, the rule may further specify an indication whether to return pop requests that are below the threshold.

The response determination module 542 is further configured to determine whether a received pop request can be satisfied (e.g., all or a portion of the requested work is available for consumption), as well as generate a message for transmission to the requesting consumer computing device 104 indicating whether the received pop request can be satisfied. If the pop request can be satisfied, the response determination module 542 is configured to generate a success message that includes a number of work elements from the producer work queue to the requesting consumer computing device 104; otherwise, the response determination module 542 is configured to generate a failure message.

In some embodiments, the response determination module 542 is configured to determine whether the received pop request can be satisfied based on the work distribution rule set and the effective availability. Additionally or alternatively, in some embodiments, the response determination module 542 is configured to determine whether the received pop request can be satisfied based on one or more of the consumption constraints received with the pop request. As described previously, the consumption constraints may include a size of the work elements of the producer work queue requested, an acceptable range of work elements of the producer work queue to receive (e.g., an upper threshold of work elements of the producer work queue to receive and a lower threshold of work elements of the producer work queue to receive), and/or a fraction of available work elements of the producer work queue to receive.

In an illustrative example in which the consumption constraints include an acceptable range between 500 and 1000 work elements (e.g., a lower threshold equal to 500 work elements and an upper threshold equal to 1000 work elements) and the effective availability is determined to be 4000 work elements, the response determination module 542 will return 1000 work elements. In another illustrative example in which the acceptable range is instead between 1500 and 5000 work elements, the response determination module 542 will return 4000 work elements. However, in a slight variance of the illustrative example in which the work distribution rule set indicates a fraction equal to one-fourth of the total available work elements, then 1000 work elements (e.g., a result of multiplying the fraction by the effective availability) would not satisfy the lower threshold and the response determination module 542 would generate a failure message. As described below, the failure message may include feedback information (e.g., as determined by the feedback determination module 544) that indicates 1000 work elements were available at the time the pop request was processed.

The feedback determination module 544 is configured to generate feedback to be transmitted to the requesting consumer computing device 104 upon a determination that the received pop request cannot be satisfied. Additionally, the feedback determination module 544 is configured to include one or more producer metrics with the failure message. For example, the feedback determination module 544 may be configured to generate the producer metrics based on heuristics and/or historical rate information, such as may be stored in the production data 506. As described previously, the producer metrics may include any data usable by the consumer computing device 104 to make a decision on a subsequent action to take upon receipt of the failure message (e.g., resend the same pop request, send another pop request that includes modified consumption constraints, wait a duration of time before taking another action, send the pop request to another producer computing device, or send the other pop request to another producer computing device).

For example, the producer metrics may include data relative to the producer work queue at the time the pop request was received, historical data of the producer computing device 102 that received the pop request, and/or system-level information. The data relative to the producer work queue at the time the pop request was received may include a total amount of work elements in the producer work queue, a total amount of available work elements in the producer work queue, a present capacity of the producer work queue, etc. The historical data may include a history of work production, a history of work distribution (e.g., consumed work), etc. In some embodiments, the historical data may be returned in a format usable by the receiving consumer computing device 104 to tune their pop request constraints. For example, the producer computing device 102 may capture and store the historical data at predetermined intervals.

As such, the historical data may include the time interval and multiple snapshots captured at the time intervals. In an illustrative embodiment, the producer computing device 102 may return the historical data in the following format: delta, [p0, p1, p2], [c0, c1, c2]; wherein delta is the time interval, [p0, p1, p2] is the number of work elements produced in each of the last time intervals, and [c0, c1, c2] is the number of work elements consumed in each of the last time intervals. The system-level information may include information corresponding to another producer computing device, such as identifying information of another producer computing device from which the producer computing device 102 had most recently stolen work, identifying information of a neighbor of the producer computing device 102 (e.g., another producer computing device), etc.

It should be appreciated that, in some embodiments, it may be desirable to return such producer metrics in the event the received pop request can be satisfied, in addition to returning producer metrics when the received pop request cannot be satisfied. For example, increasing the maximum number of work elements of the producer work queue requested can transfer the same work with fewer messages, but may be a good strategy only when production rates are frequently ahead of consumption rates. More generally, such data can help improve the efficiency of messaging (e.g., fewer but larger messages) and reduce the number and size of messages. Doing so may avoid having a first computing device pulling work from a second computing device, then a third computing device pulling some of the second computing device's work from the first computing device. As such, less data is transferred when the third computing device pulls directly from the second computing device. Accordingly, in such embodiments, the feedback determination module 544 may be configured to generate feedback to be transmitted to the requesting consumer computing device 104 upon a determination that the received pop request can be satisfied.

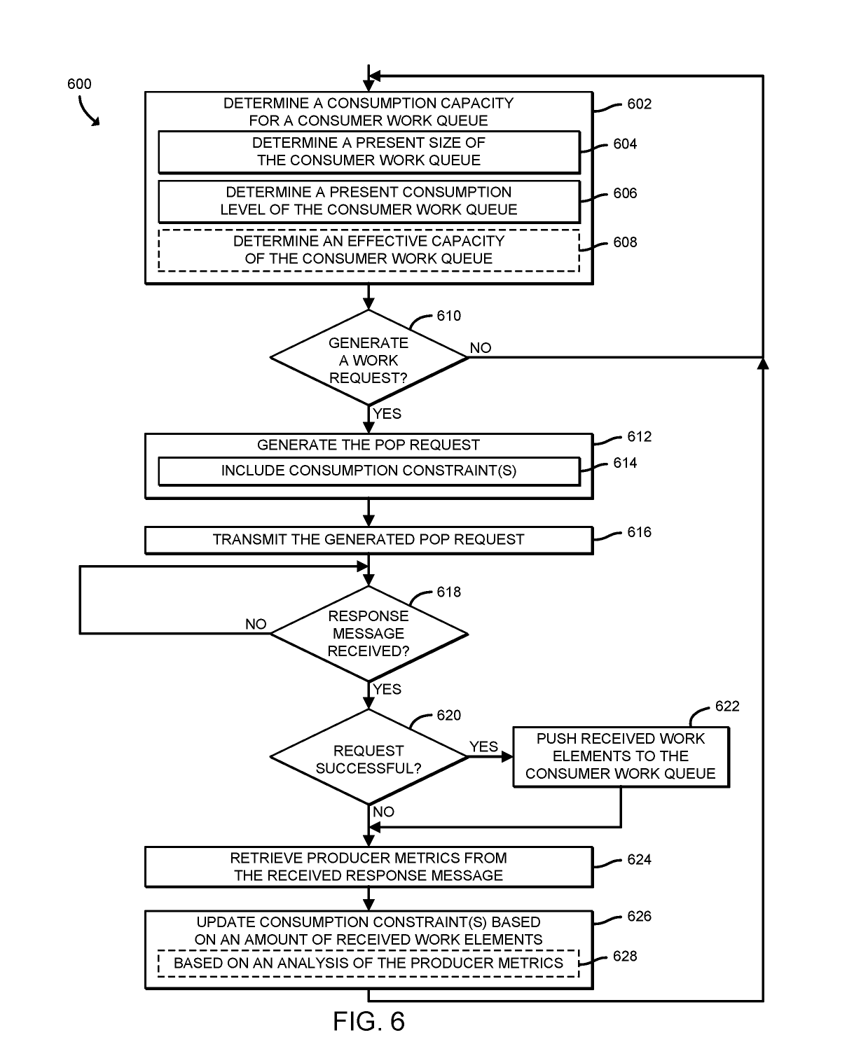

Referring now to FIG. 6, in use, a consumer computing device (e.g., one of the consumer computing devices 104 of FIG. 1) may execute a method 600 for providing hints usable to adjust properties of digital media. It should be appreciated that at least a portion of the method 600 may be embodied as various instructions stored on a computer-readable media, which may be executed by the processor 302, the communication circuitry 310, and/or other components of the consumer computing device 104 to cause the consumer computing device 104 to perform the method 600. The computer-readable media may be embodied as any type of media capable of being read by the consumer computing device 104 including, but not limited to, the memory 306, the data storage device 308, a local memory (not shown) of the NIC 312 of the communication circuitry 310, other memory or data storage devices of the consumer computing device 104, portable media readable by a peripheral device of the consumer computing device 104, and/or other media.

The method 600 begins in block 602, in which the consumer computing device 104 determines a consumption capacity for a work queue of the consumer computing device 104 (e.g., the consumer work queue). To do so, in block 604, the consumer computing device 104 is configured to determine a present size of the consumer work queue. It should be appreciated that, in some embodiments, the consumer work queue size may be dynamic and therefore the present size of the consumer work queue may change over time. Additionally, in block 606, the consumer computing device 104 determines a present consumption level (e.g., a present fullness) of the consumer work queue.

As described previously, the consumer computing device 104 may request an amount of work that is less than an actual available capacity (e.g., an amount that is less than an amount of work that would otherwise fill the consumer work queue). Accordingly, in some embodiments, in block 608, the consumer computing device 104 may additionally determine an effective capacity of the consumer work queue. As described previously, the consumer computing device 104 may be configured to determine the effective capacity as a function of an acceptable level of fullness (e.g., a capacity threshold, a maximum fullness percentage, etc.) and the present size of the consumer work queue as determined in block 606. As such, the consumer computing device 104 may use the effective capacity to request an amount of work that is less than the actual available capacity.

In some embodiments, the consumer computing device 104 may be configured to determine the consumption capacity based on an actual capacity of the consumer work queue, such as by subtracting the present consumption level of the consumer work queue from the present size of the consumer work queue determined in block 606. Alternatively, in some embodiments, the consumer computing device 104 may be configured to determine the consumption capacity by subtracting the present consumption level of the consumer work queue from the effective capacity determined in block 608.

In block 610, the consumer computing device 104 determines whether to generate the pop request (e.g., whether the consumer work queue has available capacity based on the consumption capacity determined in block 602 and/or any other conditions/triggers have been met). For example, the consumer computing device 104 may be configured to determine whether the consumption capacity or the effective capacity of the consumer work queue has exceeded a threshold capacity level. In another example, the consumer computing device 104 may be additionally or alternatively configured to determine whether a present fullness level of the consumer work queue and/or a number of present work elements of the consumer work queue is detected below request trigger threshold. In other words, the consumer computing device 104 may be configured to detect a low work level state and generate the pop request in response to a determination that a low work level state has been detected.

If the consumer computing device 104 determines not to generate the pop request, the method 600 loops back to block 602 to determine the consumption capacity again; otherwise, the method 600 advances to block 612, in which the consumer computing device 104 generates a pop request that includes an identifier of the producer computing device 102 to which the pop request is to be sent. As described previously, in some embodiments, the pop request may be a one-sided pull initiated by one of the consumer computing devices 104.

Additionally, in block 614, the consumer computing device 104 includes one or more consumption constraints with the pop request. As described previously, the consumption constraints may include any data defining acceptable limits on an amount of work elements of the producer work queue to be requested (e.g., stolen or popped) from the producer computing device 102, such as a size of the work elements of the producer work queue requested, an acceptable range of work elements of the producer work queue to receive (e.g., an upper threshold of work elements of the producer work queue to receive and a lower threshold of work elements of the producer work queue to receive), and/or a fraction of available work elements of the producer work queue to receive.

In block 616, the consumer computing device 104 transmits the pop request generated in block 612 to the applicable producer computing device (e.g., the producer computing device 102 of FIG. 1). In block 618, the consumer computing device 104 determines whether a message (e.g., a response message) has been received in response to the pop request transmitted in block 616. If so, the method 600 advances to block 620, in which the consumer computing device 104 determines whether the response message received in block 618 indicates the request was successful (e.g., some amount of the requested work elements, or an indication of the amount, has been received).

If the consumer computing device 104 determines the response message received in block 618 indicates the pop request was successful, the method 600 branches to block 622, in which the consumer computing device 104 push the received work elements into the applicable consumer work queue upon reception of the response message before the method 600 advances to block 624. It should be further appreciated that, in some embodiments, the work elements may be sent in one or more separate, additional messages. Additionally or alternatively, the received response message may include an indication of the size of the work elements (e.g., an amount of work elements) the consumer computing device 104 should expect to receive in subsequent message(s). Otherwise, if the consumer computing device 104 determines the received response message indicates the request was not successful (e.g., a failure), the method 600 branches to block 624, in which the consumer computing device 104 retrieves one or more producer metrics from the received response message.

As described previously, the producer metrics may include any data usable by the consumer computing device 104 to make subsequent decisions, such as an action to take subsequent to having received the response message (e.g., resend the same pop request, send another pop request that includes modified consumption constraints, wait a duration of time before taking another action, send the pop request to another producer computing device, or send the other pop request to another producer computing device). Accordingly, the producer metrics may include data relative to the producer work queue at the time the pop request was received, historical data of the producer computing device 102 that received the pop request, and/or system-level information (e.g., information corresponding to another producer computing device 102).

It should be appreciated that, in some embodiments, a successful request may not include any producer metrics. In block 626, the consumer computing device 104 updates the consumption constraints based on the amount of received work elements (e.g., some work elements or no work elements) In other words, the consumer computing device 104 updates the consumption constraints based on an impact on the consumer work queue of the received work elements. Additionally, in block 628, in such embodiments wherein the producer metrics were received with the response message, the consumer computing device 104 may further update the consumption constraints based on an analysis of any received producer metrics.

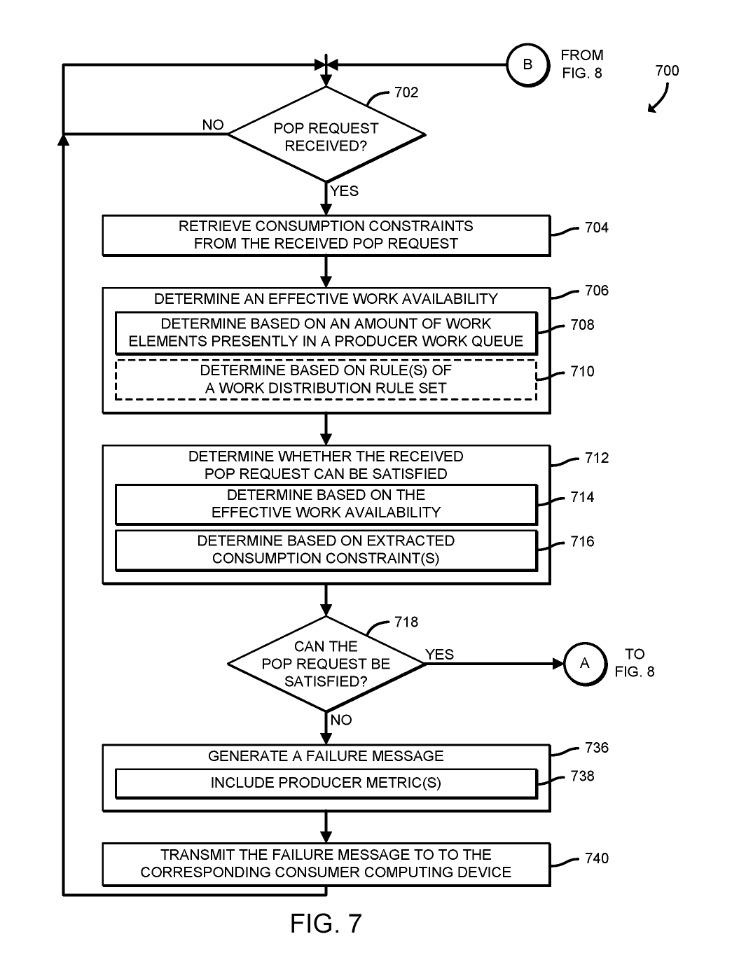

Referring now to FIG. 7, in use, a producer computing device (e.g., the producer computing device 102 of FIG. 1) may execute a method 700 for processing a pop request from a consumer computing device (e.g., one of the consumer computing devices 104 of FIG. 1). It should be appreciated that at least a portion of the method 700 may be embodied as various instructions stored on a computer-readable media, which may be executed by the processor 202, the communication circuitry 210, the queue management engine 214, and/or other components of the producer computing device 102 to cause the producer computing device 102 to perform the method 700. The computer-readable media may be embodied as any type of media capable of being read by the producer computing device 102 including, but not limited to, the memory 206, the data storage device 208, a local memory (not shown) of the NIC 212 of the communication circuitry 210, other memory or data storage devices of the producer computing device 102, portable media readable by a peripheral device of the producer computing device 102, and/or other media.

The method 700 begins in block 702, in which the producer computing device 102 determines whether a pop request has been received from a consumer computing device (e.g., one of the consumer computing devices 104 of FIG. 1). As described previously, in some embodiments, the pop request may be a one-sided pull received from the consumer computing devices. In block 704, the producer computing device 102 retrieves one or more consumption constraints from the pop request received in block 702. As described previously, the consumption constraints may include any data defining acceptable limits on an amount of work elements of the producer work queue to be requested (e.g., stolen or popped) from the producer computing device 102, such as a size of the work elements of the producer work queue requested, an acceptable range of work elements of the producer work queue to receive (e.g., an upper threshold of work elements of the producer work queue to receive and a lower threshold of work elements of the producer work queue to receive), and/or a fraction of available work elements of the producer work queue to receive.

In block 706, the producer computing device 102 determines an effective work availability (e.g., an amount of work that is available to be stolen). To do so, in block 708, the producer computing device 102 determines the effective work availability based on an amount of work elements presently in a producer work queue and a present size of the producer work queue. As noted previously, it should be appreciated that, in some embodiments, the effective work availability may be less than an actual work availability (e.g., an actual amount of work in the producer work queue) to promote fairness of the work distribution across the consumer computing devices 104. Accordingly, in some embodiments, in block 710, the producer computing device 102 may determine the effective work availability further based on one or more rules of a work distribution rule set. As described previously, the work distribution rule set includes one or more rules, or policies, usable by the producer computing device 102 to determine how to distribute available work from the producer work queues. For example, the work distribution rule set may include various minimum/maximum thresholds, such as a minimum work release threshold (e.g., a minimum total number of work elements to return per received pop request), a maximum work release threshold (e.g., a maximum total number of work elements to return per received pop request).

In block 712, the producer computing device 102 determines whether the received pop request can be satisfied. To do so, in block 714, the producer computing device 102 determines whether the received pop request can be satisfied based on the effective work availability determined in block 706. Additionally, in block 716, the producer computing device 102 further determines whether the received pop request can be satisfied based on the consumption constraint(s) retrieved in block 704. In other words, the producer computing device 102 determines whether the amount of work available that is reflected by the effective work availability satisfy the consumption constraint(s). For example, the producer computing device 102 may determine whether the effective work availability falls within a range (e.g., between an upper and lower bound) identified in the consumption constraint(s), or otherwise satisfies one or more thresholds of the pop request.

For example, in an illustrative embodiment, the producer computing device 102 determines an effective work availability of 2000 work elements of the producer work queue. In some embodiments, the producer computing device 102 may have determined the effective work availability based on an actual amount of work produced and placed (e.g., pushed) into the producer work queue (e.g., there are 2000 work elements in the producer work queue). Alternatively, in some embodiments, the producer computing device 102 may have determined the effective work availability based on a rule, such as a rule that identifies a fraction from which a maximum distribution threshold per pop request may be determined (e.g., there are 8000 work elements in the producer work queue and the fraction indicates that one-fourth of the work elements in the producer work queue may be distributed resulting from any one pop request).

In another illustrative embodiment, the producer computing device 102 may apply a rule that indicates not to distribute more than one-fourth of the work elements in the producer work queue in response to any one pop request. In such an embodiment, the producer computing device 102 may determine there are 3 work elements, in which case applying the rule always results in zero, even if the pop request is only for 1 work element. Accordingly, in some embodiments, the one or more additional rules may include a minimum threshold and/or an indicator whether it is acceptable to return an amount of work elements that fall below the minimum threshold.

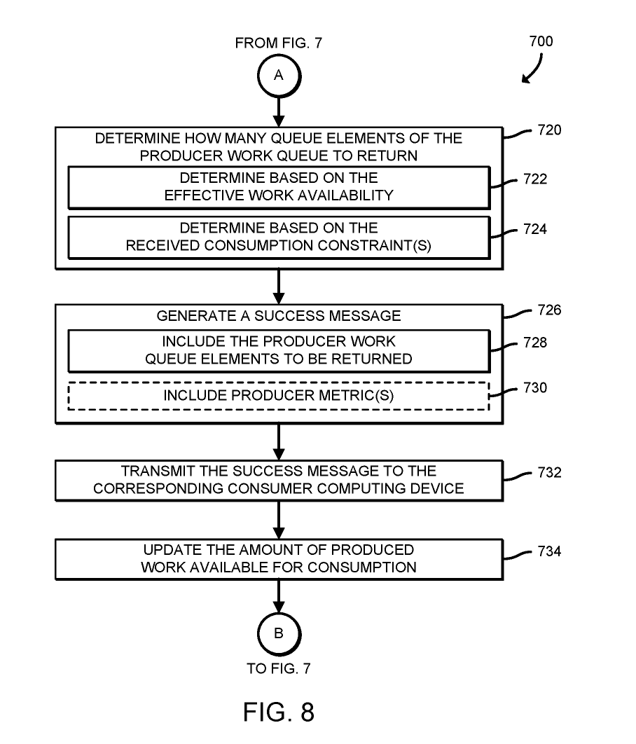

In block 718, the producer computing device 102 determines whether the pop request can be satisfied. If so, the method 700 branches to block 736, described below; otherwise, the method 700 branches to block 720 of FIG. 8. In block 720, the producer computing device 102 determines how many work elements of the producer work queue to return. To do so, in block 722, the producer computing device 102 determines the number of work elements of the producer work queue to return based on the effective work availability. Additionally, in block 724, the producer computing device 102 determines the number of work elements of the producer work queue to return based on one or more of the received consumption constraints. In an illustrative example, the producer computing device 102 may determine the number of work elements of the producer work queue to return based on whether the effective work availability falls within an acceptable range dictated by the consumption constraints.

In block 726, the producer computing device 102 generates a success message. Further, in block 728, the producer computing device 102 includes the work elements of the producer work queue and/or an indication of a number of work elements of the producer work queue to be subsequently transmitted. Additionally, in some embodiments, in block 730, the producer computing device 102 may include one or more producer metrics. As described previously, the producer metrics may include any data usable by the consumer computing device 104 to make subsequent decisions, such as an action to take subsequent to having received the response message (e.g., resend the same pop request, send another pop request that includes modified consumption constraints, wait a duration of time before taking another action, send the pop request to another producer computing device, or send the other pop request to another producer computing device). Accordingly, the producer metrics may include data relative to the producer work queue at the time the pop request was received, historical data of the producer computing device 102 that received the pop request, and/or system-level information (e.g., information corresponding to another producer computing device 102).

In block 732, the producer computing device 102 transmits the produced data and/or the indication of the size of the produced data to be returned to the consumer computing device 104 from which the pop request was received. In block 734, the producer computing device 102 updates an amount of produced work available for consumption before the method 700 returns to block 702 to determine whether another pop request has been received.

Referring again to block 718 of FIG. 7, if the producer computing device 102 determines the pop request can be satisfied, the method advances to block 736, in which the producer computing device 102 generates a failure message. Further, in block 738, the producer computing device 102 includes one or more producer metrics with the failure message. In block 740, the producer computing device 102 transmits the failure message to the corresponding consumer computing device 104 from which the pop request was received before the method 700 returns to block 702 to determine whether another pop request has been received. It should be appreciated that, in some embodiments, no failure message is sent to indicate the failure (e.g., no response infers a failure). Additionally or alternatively, in some embodiments, the failure message may be queued until another pop request has been received and cannot be satisfied. In such embodiments, the producer metrics resulting from the determination of multiple failure messages (e.g., in response to the previous pop request and the present pop request) may be aggregated and returned in a single failure message. In other words, a single set of producer metrics may satisfy more than one pop request.

### Examples

Illustrative examples of the technologies disclosed herein are provided below. An embodiment of the technologies may include any one or more, and any combination of, the examples described below.

Example 1 includes a producer computing device for dynamic work queue management, the producer computing device comprising one or more processors; and one or more memory devices having stored therein a plurality of instructions that, when executed by the one or more processors, cause the producer computing device to receive a pop request from a consumer computing device, wherein the pop request includes one or more consumption constraints; determine an effective work availability of a producer work queue of the producer computing device, wherein the effective work availability indicates a number of work elements of the producer work queue available to be stolen; determine whether the received pop request can be satisfied based on the effective work availability and the one or more consumption constraints; determine one or more producer metrics, wherein the producer metrics are usable by the consumer computing device to determine a subsequent action to be performed by the consumer computing device upon receipt of the response message; generate, in response to a determination the received pop request cannot be satisfied, a failure message that includes one or more of the producer metrics; and transmit the failure message to the consumer computing device.

Example 2 includes the subject matter of Example 1, and wherein the plurality of instructions further cause the producer computing device to determine a present size of the producer work queue and a number of work elements presently in the producer work queue, and wherein to determine the effective work availability comprises to determine the effective work availability as a function of the present size of the producer work queue and the number of work elements presently in the producer work queue.

Example 3 includes the subject matter of any of Examples 1 and 2, and wherein to determine the effective work availability comprises to determine the effective work availability based on one or more rules of a work distribution rule set, wherein the one or more rules define how to distribute the work elements from the producer work queue.

Example 4 includes the subject matter of any of Examples 1-3, and wherein the one or more rules of the work distribution rule set define at least one of a minimum number of work elements to return per received pop request, a maximum number of work elements to return per received pop request, or a fraction of the work elements to return per received pop request.

Example 5 includes the subject matter of any of Examples 1-4, and wherein the producer metrics include at least one of data relative to the producer work queue at the time the pop request was received, historical data of the producer computing device to which the pop request was sent, or information corresponding to another producer computing device.

Example 6 includes the subject matter of any of Examples 1-5, and wherein the data relative to the producer work queue at the time the pop request was received includes at least one of a total amount of work elements in the producer work queue, a total amount of available work elements in the producer work queue, or a present capacity of the producer work queue.

Example 7 includes the subject matter of any of Examples 1-6, and wherein the historical data includes at least one of a history of work production or a history of work distribution.

Example 8 includes the subject matter of any of Examples 1-7, and wherein the information corresponding to the other producer computing device includes at least one of identifying information of another producer computing device from which the producer computing device had most recently stolen work or identifying information of another producer computing device.

Example 9 includes the subject matter of any of Examples 1-8, and wherein the plurality of instructions further cause the producer computing device to perform a pop operation on each of the work elements of the producer work queue to be returned; generate, in response to a determination the received pop request can be satisfied, a success message that includes the work elements of the producer work queue to be returned; and transmit the success message to the consumer computing device.

Example 10 includes the subject matter of any of Examples 1-9, and wherein to transmit the success message to the consumer computing device comprises to transmit the work elements and one or more of the producer metrics.

Example 11 includes the subject matter of any of Examples 1-10, and wherein the consumption constraints include at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

Example 12 includes a producer computing device for dynamic work queue management, the producer computing device comprising a communication management circuit to receive a pop request from a consumer computing device, wherein the pop request includes one or more consumption constraints; and a pop request response generation circuit to determine an effective work availability of a producer work queue of the producer computing device, wherein the effective work availability indicates a number of work elements of the producer work queue available to be stolen; determine whether the received pop request can be satisfied based on the effective work availability and the one or more consumption constraints; determine one or more producer metrics, wherein the producer metrics are usable by the consumer computing device to determine a subsequent action to be performed by the consumer computing device upon receipt of the response message; and generate, in response to a determination the received pop request cannot be satisfied, a failure message that includes one or more of the producer metrics, wherein the communication management circuit is further to transmit the failure message to the consumer computing device.

Example 13 includes the subject matter of Example 12, and wherein the pop request response generation circuit is further to determine a present size of the producer work queue and a number of work elements presently in the producer work queue, and wherein to determine the effective work availability comprises to determine the effective work availability as a function of the present size of the producer work queue and the number of work elements presently in the producer work queue.

Example 14 includes the subject matter of any of Examples 12 and 13, and wherein to determine the effective work availability comprises to determine the effective work availability based on one or more rules of a work distribution rule set, wherein the one or more rules define how to distribute the work elements from the producer work queue.

Example 15 includes the subject matter of any of Examples 12-14, and wherein the one or more rules of the work distribution rule set define at least one of a minimum number of work elements to return per received pop request, a maximum number of work elements to return per received pop request, or a fraction of the work elements to return per received pop request.

Example 16 includes the subject matter of any of Examples 12-15, and wherein the producer metrics include at least one of data relative to the producer work queue at the time the pop request was received, historical data of the producer computing device to which the pop request was sent, or information corresponding to another producer computing device.

Example 17 includes the subject matter of any of Examples 12-16, and, wherein the data relative to the producer work queue at the time the pop request was received includes at least one of a total amount of work elements in the producer work queue, a total amount of available work elements in the producer work queue, or a present capacity of the producer work queue.

Example 18 includes the subject matter of any of Examples 12-17, and wherein the historical data includes at least one of a history of work production or a history of work distribution.

Example 19 includes the subject matter of any of Examples 12-18, and wherein the information corresponding to the other producer computing device includes at least one of identifying information of another producer computing device from which the producer computing device had most recently stolen work or identifying information of another producer computing device.

Example 20 includes the subject matter of any of Examples 12-19, and further including a producer work queue management circuit to perform a pop operation on each of the work elements of the producer work queue to be returned; generate, in response to a determination the received pop request can be satisfied, a success message that includes the work elements of the producer work queue to be returned; and transmit the success message to the consumer computing device.

Example 21 includes the subject matter of any of Examples 12-20, and wherein to transmit the success message to the consumer computing device comprises to transmit the work elements and one or more of the producer metrics.

Example 22 includes the subject matter of any of Examples 12-21, and wherein the consumption constraints include at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

Example 23 includes a method for dynamic work queue management, the method comprising receiving, by a producer computing device, a pop request from a consumer computing device, wherein the pop request includes one or more consumption constraints; determining, by the producer computing device, an effective work availability of a producer work queue of the producer computing device, wherein the effective work availability indicates a number of work elements of the producer work queue available to be stolen; determining, by the producer computing device, whether the received pop request can be satisfied based on the effective work availability and the one or more consumption constraints; determining, by the producer computing device, one or more producer metrics, wherein the producer metrics are usable by the consumer computing device to determine a subsequent action to be performed by the consumer computing device upon receipt of the response message; generating, by the producer computing device and in response to a determination the received pop request cannot be satisfied, a failure message that includes one or more of the producer metrics; and transmitting, by the producer computing device, the failure message to the consumer computing device.

Example 24 includes the subject matter of Example 23, and further including determining a present size of the producer work queue and a number of work elements presently in the producer work queue, and wherein determining the effective work availability comprises determining the effective work availability as a function of the present size of the producer work queue and the number of work elements presently in the producer work queue.

Example 25 includes the subject matter of any of Examples 23 and 24, and wherein determining the effective work availability comprises determining the effective work availability based on one or more rules of a work distribution rule set, wherein the one or more rules define how to distribute the work elements from the producer work queue.

Example 26 includes the subject matter of any of Examples 23-25, and wherein the one or more rules of the work distribution rule set define at least one of a minimum number of work elements to return per received pop request, a maximum number of work elements to return per received pop request, or a fraction of the work elements to return per received pop request.

Example 27 includes the subject matter of any of Examples 23-26, and wherein determining the producer metrics comprises determining at least one of data relative to the producer work queue at the time the pop request was received, historical data of the producer computing device to which the pop request was sent, or information corresponding to another producer computing device.

Example 28 includes the subject matter of any of Examples 23-27, and wherein determining the data relative to the producer work queue at the time the pop request was received comprises determining at least one of a total amount of work elements in the producer work queue, a total amount of available work elements in the producer work queue, or a present capacity of the producer work queue.

Example 29 includes the subject matter of any of Examples 23-28, and wherein determining the historical data comprises determining at least one of a history of work production or a history of work distribution.

Example 30 includes the subject matter of any of Examples 23-29, and wherein determining the information corresponding to the other producer computing device comprises determining at least one of identifying information of another producer computing device from which the producer computing device had most recently stolen work or identifying information of another producer computing device.

Example 31 includes the subject matter of any of Examples 23-30, and further including performing, by the producer computing device, a pop operation on each of the work elements of the producer work queue to be returned; generating, by the producer computing device and in response to a determination the received pop request can be satisfied, a success message that includes the work elements of the producer work queue to be returned; and transmitting, by the producer computing device, the success message to the consumer computing device.

Example 32 includes the subject matter of any of Examples 23-31, and wherein transmitting the success message to the consumer computing device comprises transmitting the work elements and one or more of the producer metrics.

Example 33 includes the subject matter of any of Examples 23-32, and wherein identifying the consumption constraints comprises identifying at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

Example 34 includes a producer computing device comprising a processor; and a memory having stored therein a plurality of instructions that when executed by the processor cause the producer computing device to perform the method of any of Examples 23-33.

Example 35 includes one or more machine readable storage media comprising a plurality of instructions stored thereon that in response to being executed result in a producer computing device performing the method of any of Examples 23-33.

Example 36 includes a producer computing device for dynamic work queue management, the producer computing device comprising a communication management circuit to receive a pop request from a consumer computing device, wherein the pop request includes one or more consumption constraints; means for determining an effective work availability of a producer work queue of the producer computing device, wherein the effective work availability indicates a number of work elements of the producer work queue available to be stolen; means for determining whether the received pop request can be satisfied based on the effective work availability and the one or more consumption constraints; means for determining one or more producer metrics, wherein the producer metrics are usable by the consumer computing device to determine a subsequent action to be performed by the consumer computing device upon receipt of the response message; and means for generating a failure message that includes one or more of the producer metrics, wherein the communication management circuit is further to transmit the failure message to the consumer computing device.

Example 37 includes the subject matter of Example 36, and further including a pop request response generation circuit to determine a present size of the producer work queue and a number of work elements presently in the producer work queue, and wherein the means for determining the effective work availability comprises means for determining the effective work availability as a function of the present size of the producer work queue and the number of work elements presently in the producer work queue.

Example 38 includes the subject matter of any of Examples 36 and 37, and wherein the means for determining the effective work availability comprises means for determining the effective work availability based on one or more rules of a work distribution rule set, wherein the one or more rules define how to distribute the work elements from the producer work queue.

Example 39 includes the subject matter of any of Examples 36-38, and wherein the one or more rules of the work distribution rule set define at least one of a minimum number of work elements to return per received pop request, a maximum number of work elements to return per received pop request, or a fraction of the work elements to return per received pop request.

Example 40 includes the subject matter of any of Examples 36-39, and wherein the means for determining the producer metrics comprises means for determining at least one of data relative to the producer work queue at the time the pop request was received, historical data of the producer computing device to which the pop request was sent, or information corresponding to another producer computing device.

Example 41 includes the subject matter of any of Examples 36-40, and wherein the means for determining the data relative to the producer work queue at the time the pop request was received comprises means for determining at least one of a total amount of work elements in the producer work queue, a total amount of available work elements in the producer work queue, or a present capacity of the producer work queue.

Example 42 includes the subject matter of any of Examples 36-41, and wherein the means for determining the historical data comprises means for determining at least one of a history of work production or a history of work distribution.

Example 43 includes the subject matter of any of Examples 36-42, and wherein the means for determining the information corresponding to the other producer computing device comprises means for determining at least one of identifying information of another producer computing device from which the producer computing device had most recently stolen work or identifying information of another producer computing device.

Example 44 includes the subject matter of any of Examples 36-43, and further including a producer work queue management circuit to perform a pop operation on each of the work elements of the producer work queue to be returned; generate, in response to a determination the received pop request can be satisfied, a success message that includes the work elements of the producer work queue to be returned; and transmit the success message to the consumer computing device.

Example 45 includes the subject matter of any of Examples 36-44, and wherein to transmit the success message to the consumer computing device comprises to transmit the work elements and one or more of the producer metrics.

Example 46 includes the subject matter of any of Examples 36-45, and wherein the means for identifying the consumption constraints comprises means for identifying at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

Example 47 includes a consumer computing device for dynamic work queue management, the consumer computing device comprising one or more processors; and one or more memory devices having stored therein a plurality of instructions that, when executed by the one or more processors, cause the consumer computing device to determine a consumption capacity for a consumer work queue of the consumer computing device, wherein the consumer work queue includes work to be consumed by the consumer computing device; generate one or more consumption constraints, wherein the consumption constraints define acceptable limits on a number of work elements of a producer work queue of a producer computing device to be requested; determine whether the consumer work queue has available capacity based on the determined consumption capacity; generate, in response to a determination that the consumer work queue has available capacity, a pop request that includes one or more of the consumption constraints; transmit the pop request to the producer computing device; receive a response message from the producer computing device, wherein the response message includes an indication of success of the pop request; and push, in response to a determination that the indication of success indicates that the pop request was successful, a number of work elements received with the response message to the consumer work queue.

Example 48 includes the subject matter of Example 47, and wherein the plurality of instructions further cause the consumer computing device to determine a present size of the consumer work queue; and determine a present consumption level of the consumer work queue, wherein to determine the consumption capacity comprises to determine the consumption capacity as a function of the present size of the consumer work queue and the present consumption level of the consumer work queue.

Example 49 includes the subject matter of any of Examples 47 and 48, and wherein the plurality of instructions further cause the consumer computing device to determine a present size of the consumer work queue; and determine an effective capacity of the consumer work queue, wherein the effective capacity identifies a maximum amount of work to be requested, and wherein to determine the consumption capacity comprises to determine the consumption capacity based on the effective capacity of the consumer work queue.

Example 50 includes the subject matter of any of Examples 47-49, and wherein to determine the effective capacity of the consumer work queue comprises to determine the effective capacity as a function of a capacity threshold and the present size of the consumer work queue.

Example 51 includes the subject matter of any of Examples 47-50, and wherein the capacity threshold comprises a maximum fullness percentage that defines a maximum fullness level of the consumer work queue.

Example 52 includes the subject matter of any of Examples 47-51, and wherein the plurality of instructions further cause the consumer computing device to retrieve, in response to a determination that the indication of success indicates that the pop request was not successful, one or more producer metrics from the received response message; and update one or more of the consumption constraints based on one or more of the retrieved producer metrics.

Example 53 includes the subject matter of any of Examples 47-52, and wherein the plurality of instructions further cause the consumer computing device to determine a subsequent action to be performed upon receipt of the response message, wherein to perform the subsequent action comprises to determine to resend the same pop request, send another pop request that includes modified consumption constraints, wait a duration of time before taking another action, send the pop request to another producer computing device, or send the other pop request to the other producer computing device; and perform the determined subsequent action.

Example 54 includes the subject matter of any of Examples 47-53, and wherein the producer metrics include at least one of data relative to the producer work queue at the time the pop request was received, historical data of the producer computing device to which the pop request was sent, or information corresponding to another producer computing device.

Example 55 includes the subject matter of any of Examples 47-54, and wherein the data relative to the producer work queue at the time the pop request was received includes at least one of a total amount of work elements in the producer work queue, a total amount of available work elements in the producer work queue, or a present capacity of the producer work queue.

Example 56 includes the subject matter of any of Examples 47-55, and wherein the historical data includes at least one of a history of work production or a history of work distribution.

Example 57 includes the subject matter of any of Examples 47-56, and wherein the information corresponding to the other producer computing device includes at least one of identifying information of another producer computing device from which the producer computing device had most recently stolen work or identifying information of the other producer computing device.

Example 58 includes the subject matter of any of Examples 47-57, and wherein the consumption constraints include at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

Example 59 includes a consumer computing device for dynamic work queue management, the consumer computing device comprising a consumption capacity determination circuit to determine a consumption capacity for a consumer work queue of the consumer computing device, wherein the consumer work queue includes work to be consumed by the consumer computing device; a consumption constraint management circuit to (i) generate one or more consumption constraints, wherein the consumption constraints define acceptable limits on a number of work elements of a producer work queue of a producer computing device to be requested and (ii) determine whether the consumer work queue has available capacity based on the determined consumption capacity; a pop request generation circuit to generate, in response to a determination that the consumer work queue has available capacity, a pop request that includes one or more of the consumption constraints; a communication management circuit to (i) transmit the pop request to the producer computing device and (ii) receive a response message from the producer computing device, wherein the response message includes an indication of success of the pop request, a consumer work queue management circuit to push, in response to a determination that the indication of success indicates that the pop request was successful, a number of work elements received with the response message to the consumer work queue.

Example 60 includes the subject matter of Example 59, and wherein to determine the consumption capacity comprises to (i) determine a present size of the consumer work queue, (ii) determine a present consumption level of the consumer work queue, and (iii) determine the consumption capacity as a function of the present size of the consumer work queue and the present consumption level of the consumer work queue.

Example 61 includes the subject matter of any of Examples 59 and 60, and wherein to determine the consumption capacity comprises to determine a present size of the consumer work queue; determine an effective capacity of the consumer work queue, wherein the effective capacity identifies a maximum amount of work to be requested; and determine the consumption capacity as a function of the effective capacity of the consumer work queue.

Example 62 includes the subject matter of any of Examples 59-61, and wherein to determine the effective capacity of the consumer work queue comprises to determine the effective capacity as a function of a capacity threshold and the present size of the consumer work queue.

Example 63 includes the subject matter of any of Examples 59-62, and wherein the capacity threshold comprises a maximum fullness percentage that defines a maximum fullness level of the consumer work queue.

Example 64 includes the subject matter of any of Examples 59-63, and wherein the consumption constraint management circuit is further to retrieve, in response to a determination that the indication of success indicates that the pop request was not successful, one or more producer metrics from the received response message; and update one or more of the consumption constraints based on one or more of the retrieved producer metrics.

Example 65 includes the subject matter of any of Examples 59-64, and wherein the consumer computing device is further to determine a subsequent action to be performed upon receipt of the response message, wherein to perform the subsequent action comprises to determine to resend the same pop request, send another pop request that includes modified consumption constraints, wait a duration of time before taking another action, send the pop request to another producer computing device, or send the other pop request to the other producer computing device; and perform the determined subsequent action.

Example 66 includes the subject matter of any of Examples 59-65, and wherein the producer metrics include at least one of data relative to the producer work queue at the time the pop request was received, historical data of the producer computing device to which the pop request was sent, or information corresponding to another producer computing device.

Example 67 includes the subject matter of any of Examples 59-66, and wherein the data relative to the producer work queue at the time the pop request was received includes at least one of a total amount of work elements in the producer work queue, a total amount of available work elements in the producer work queue, or a present capacity of the producer work queue.

Example 68 includes the subject matter of any of Examples 59-67, and wherein the historical data includes at least one of a history of work production or a history of work distribution.

Example 69 includes the subject matter of any of Examples 59-68, and wherein the information corresponding to the other producer computing device includes at least one of identifying information of another producer computing device from which the producer computing device had most recently stolen work or identifying information of the other producer computing device.

Example 70 includes the subject matter of any of Examples 59-69, and wherein the consumption constraints include at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

Example 71 includes a method for dynamic work queue management, the method comprising determining, by a consumer computing device, a consumption capacity for a consumer work queue of the consumer computing device, wherein the consumer work queue includes work to be consumed by the consumer computing device; generating, by the consumer computing device, one or more consumption constraints, wherein the consumption constraints define acceptable limits on a number of work elements of a producer work queue of a producer computing device to be requested; determining, by the consumer computing device, whether the consumer work queue has available capacity based on the determined consumption capacity; generating, by the consumer computing device and in response to a determination that the consumer work queue has available capacity, a pop request that includes one or more of the consumption constraints; transmitting, by the consumer computing device, the pop request to the producer computing device; receiving, by the consumer computing device, a response message from the producer computing device, wherein the response message includes an indication of success of the pop request; and pushing, by the consumer computing device and in response to a determination that the indication of success indicates that the pop request was successful, a number of work elements received with the response message to the consumer work queue.

Example 72 includes the subject matter of Example 71, and wherein determining the consumption capacity comprises determining, by the consumer computing device, a present size of the consumer work queue; determining, by the consumer computing device, a present consumption level of the consumer work queue; and determining the consumption capacity as a function of the present size of the consumer work queue and the present consumption level of the consumer work queue.

Example 73 includes the subject matter of any of Examples 71 and 72, and further including determining, by the consumer computing device, a present size of the consumer work queue; and determining, by the consumer computing device, an effective capacity of the consumer work queue, wherein the effective capacity identifies a maximum amount of work to be requested, and wherein determining the consumption capacity comprises determining the consumption capacity based on the effective capacity of the consumer work queue.

Example 74 includes the subject matter of any of Examples 71-73, and wherein determining the effective capacity of the consumer work queue comprises determining the effective capacity as a function of a capacity threshold and the present size of the consumer work queue.

Example 75 includes the subject matter of any of Examples 71-74, and wherein determining the capacity threshold comprises determining a maximum fullness percentage that defines a maximum fullness level of the consumer work queue.

Example 76 includes the subject matter of any of Examples 71-75, and further including retrieving, by the consumer computing device and in response to a determination that the indication of success indicates that the pop request was not successful, one or more producer metrics from the received response message; and updating, by the consumer computing device, one or more of the consumption constraints based on one or more of the retrieved producer metrics.

Example 77 includes the subject matter of any of Examples 71-76, and further including determining, by the consumer computing device, a subsequent action to be performed upon receipt of the response message, wherein determining the subsequent action comprises determining to resend the same pop request, send another pop request that includes modified consumption constraints, wait a duration of time before taking another action, send the pop request to another producer computing device, or send the other pop request to the other producer computing device; and performing, by the consumer computing device, the determined subsequent action.

Example 78 includes the subject matter of any of Examples 71-77, and wherein retrieving the producer metrics comprises retrieving at least one of data relative to the producer work queue at the time the pop request was received, historical data of the producer computing device to which the pop request was sent, or information corresponding to another producer computing device.

Example 79 includes the subject matter of any of Examples 71-78, and wherein retrieving the data relative to the producer work queue at the time the pop request was received comprises retrieving at least one of a total amount of work elements in the producer work queue, a total amount of available work elements in the producer work queue, or a present capacity of the producer work queue.

Example 80 includes the subject matter of any of Examples 71-79, and wherein retrieving the historical data comprises retrieving at least one of a history of work production or a history of work distribution.

Example 81 includes the subject matter of any of Examples 71-80, and wherein retrieving the information corresponding to the other producer computing device comprises retrieving at least one of identifying information of another producer computing device from which the producer computing device had most recently stolen work or identifying information of the other producer computing device.

Example 82 includes the subject matter of any of Examples 71-81, and wherein retrieving the consumption constraints comprises retrieving at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

Example 83 includes a consumer computing device comprising a processor; and a memory having stored therein a plurality of instructions that when executed by the processor cause the consumer computing device to perform the method of any of Examples 71-82.

Example 84 includes one or more machine readable storage media comprising a plurality of instructions stored thereon that in response to being executed result in a consumer computing device performing the method of any of Examples 71-82.

Example 85 includes a consumer computing device for dynamic work queue management, the consumer computing device comprising means for determining a consumption capacity for a consumer work queue of the consumer computing device, wherein the consumer work queue includes work to be consumed by the consumer computing device; means for generating one or more consumption constraints, wherein the consumption constraints define acceptable limits on a number of work elements of a producer work queue of a producer computing device to be requested; means for determining whether the consumer work queue has available capacity based on the determined consumption capacity; a pop request generation circuit to generate, in response to a determination that the consumer work queue has available capacity, a pop request that includes one or more of the consumption constraints; a communication management circuit to (i) transmit the pop request to the producer computing device and (ii) receive a response message from the producer computing device, wherein the response message includes an indication of success of the pop request; and a consumer work queue management circuit to push, in response to a determination that the indication of success indicates that the pop request was successful, a number of work elements received with the response message to the consumer work queue.

Example 86 includes the subject matter of Example 85, and wherein the means for determining the consumption capacity comprises means for determining a present size of the consumer work queue; means for determining a present consumption level of the consumer work queue; and means for determining the consumption capacity as a function of the present size of the consumer work queue and the present consumption level of the consumer work queue.

Example 87 includes the subject matter of any of Examples 85 and 86, and wherein the consumer work queue management circuit is further to determine a present size of the consumer work queue; and further comprising means for determining an effective capacity of the consumer work queue, wherein the effective capacity identifies a maximum amount of work to be requested, and wherein determining the consumption capacity comprises determining the consumption capacity based on the effective capacity of the consumer work queue.

Example 88 includes the subject matter of any of Examples 85-87, and wherein the means for determining the effective capacity of the consumer work queue comprises means for determining the effective capacity as a function of a capacity threshold and the present size of the consumer work queue.

Example 89 includes the subject matter of any of Examples 85-88, and wherein the means for determining the capacity threshold comprises means for determining a maximum fullness percentage that defines a maximum fullness level of the consumer work queue.

Example 90 includes the subject matter of any of Examples 85-89, and further including means for retrieving, in response to a determination that the indication of success indicates that the pop request was not successful, one or more producer metrics from the received response message; and means for updating one or more of the consumption constraints based on one or more of the retrieved producer metrics.

Example 91 includes the subject matter of any of Examples 85-90, and further including means for determining a subsequent action to be performed upon receipt of the response message, wherein determining the subsequent action comprises determining to resend the same pop request, send another pop request that includes modified consumption constraints, wait a duration of time before taking another action, send the pop request to another producer computing device, or send the other pop request to the other producer computing device; and means for performing the determined subsequent action.

Example 92 includes the subject matter of any of Examples 85-91, and wherein the means for retrieving the producer metrics comprises means for retrieving at least one of data relative to the producer work queue at the time the pop request was received, historical data of the producer computing device to which the pop request was sent, or information corresponding to another producer computing device.

Example 93 includes the subject matter of any of Examples 85-92, and wherein the means for retrieving the data relative to the producer work queue at the time the pop request was received comprises means for retrieving at least one of a total amount of work elements in the producer work queue, a total amount of available work elements in the producer work queue, or a present capacity of the producer work queue.

Example 94 includes the subject matter of any of Examples 85-93, and wherein the means for retrieving the historical data comprises means for retrieving at least one of a history of work production or a history of work distribution.

Example 95 includes the subject matter of any of Examples 85-94, and wherein the means for retrieving the information corresponding to the other producer computing device comprises means for retrieving at least one of identifying information of another producer computing device from which the producer computing device had most recently stolen work or identifying information of the other producer computing device.

Example 96 includes the subject matter of any of Examples 85-95, and wherein the means for retrieving the consumption constraints comprises means for retrieving at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

1. A producer computing device for dynamic work queue management, the producer computing device comprising:
one or more processors; and
one or more memory devices having stored therein a plurality of instructions that, when executed by the one or more processors, cause the producer computing device to:
determine an effective work availability of a producer work queue of the producer computing device, wherein the producer work queue includes a plurality of work elements, wherein the effective work availability indicates how many work elements of the producer work queue are available to be stolen;
determine whether a pop request received from a consumer computing device can be satisfied based on the effective work availability and one or more consumption constraints included in the pop request;
determine one or more producer metrics usable by the consumer computing device to determine a subsequent action to be performed by the consumer computing device;
generate, in response to a determination the received pop request cannot be satisfied, a failure message that includes one or more of the producer metrics; and
transmit the failure message to the consumer computing device.

2. The producer computing device of claim 1, wherein the plurality of instructions further cause the producer computing device to determine a present size of the producer work queue and a number of work elements presently in the producer work queue, and wherein to determine the effective work availability comprises to determine the effective work availability as a function of the present size of the producer work queue and the number of work elements presently in the producer work queue.

3. The producer computing device of claim 1, wherein to determine the effective work availability comprises to determine the effective work availability based on one or more rules of a work distribution rule set, wherein the one or more rules of the work distribution rule set define at least one of a minimum number of work elements to return per received pop request, a maximum number of work elements to return per received pop request, or a fraction of the work elements to return per received pop request.

4. The producer computing device of claim 1, wherein the producer metrics include at least one of data relative to the producer work queue at a point in time at which the pop request was received, historical data of the producer computing device to which the pop request was sent, or information corresponding to another producer computing device.

5. The producer computing device of claim 4, wherein the data relative to the producer work queue at the point in time at which the pop request was received includes at least one of a total amount of work elements in the producer work queue, a total amount of available work elements in the producer work queue, or a present capacity of the producer work queue.

6. The producer computing device of claim 1, wherein the plurality of instructions further cause the producer computing device to:
perform a pop operation on each of the work elements of the producer work queue to be returned;
generate, in response to a determination the received pop request can be satisfied, a success message that includes the work elements of the producer work queue to be returned; and
transmit the success message to the consumer computing device.

7. The producer computing device of claim 6, wherein to transmit the success message to the consumer computing device comprises to transmit the work elements and one or more of the producer metrics.

8. The producer computing device of claim 1, wherein the one or more consumption constraints include at least one of a size of the work elements of the producer work queue requested, an acceptable range a number of work elements of the producer work queue to receive, an upper threshold of work elements of the producer work queue to receive, a lower threshold of work elements of the producer work queue to receive, or a fraction of the work elements of the producer work queue to receive.

9. One or more computer-readable storage media comprising a plurality of instructions stored thereon that in response to being executed cause a producer computing device to:
determine an effective work availability of a producer work queue of the producer computing device, wherein the producer work queue includes a plurality of work elements, wherein the effective work availability indicates a number of work elements of the producer work queue available to be stolen;
determine whether a pop request received from a consumer computing device received pop request can be satisfied based on the effective work availability and one or more consumption constraints included in the pop request;
determine one or more producer metrics usable by the consumer computing device to determine a subsequent action to be performed by the consumer computing device;
generate, in response to a determination the received pop request cannot be satisfied, a failure message that includes one or more of the producer metrics; and
transmit the failure message to the consumer computing device.

10. The producer computing device of claim 9, wherein the plurality of instructions further cause the producer computing device to determine a present size of the producer work queue and a number of work elements presently in the producer work queue, and wherein to determine the effective work availability comprises to determine the effective work availability as a function of the present size of the producer work queue and the number of work elements presently in the producer work queue.

11. The one or more computer-readable storage media of claim 9, wherein to determine the effective work availability comprises to determine the effective work availability based on one or more rules of a work distribution rule set, wherein the one or more rules of the work distribution rule set define at least one of a minimum number of work elements to return per received pop request, a maximum number of work elements to return per received pop request, or a fraction of the work elements to return per received pop request.

12. The one or more computer-readable storage media of claim 9, wherein the producer metrics include at least one of data relative to the producer work queue at a point in time at which the pop request was received, historical data of the producer computing device to which the pop request was sent, or information corresponding to another producer computing device.

13. The one or more computer-readable storage media of claim 12, wherein the data relative to the producer work queue at the point in time at which the pop request was received includes at least one of a total amount of work elements in the producer work queue, a total amount of available work elements in the producer work queue, or a present capacity of the producer work queue.

14. The one or more computer-readable storage media of claim 9, wherein the plurality of instructions further cause the producer computing device to:
perform a pop operation on each of the work elements of the producer work queue to be returned;
generate, in response to a determination the received pop request can be satisfied, a success message that includes the work elements of the producer work queue to be returned; and
transmit the success message to the consumer computing device.

15. The one or more computer-readable storage media of claim 14, wherein to transmit the success message to the consumer computing device comprises to transmit the work elements and one or more of the producer metrics.

16. The one or more computer-readable storage media of claim 9, wherein the one or more consumption constraints include at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

17. A method for dynamic work queue management, the method comprising:
determining, by the producer computing device, an effective work availability of a producer work queue of the producer computing device, wherein the producer work queue includes a plurality of work elements, wherein the effective work availability indicates a number of work elements of the producer work queue available to be stolen;
determining, by the producer computing device, whether a pop request received from a consumer computing device can be satisfied based on the effective work availability and one or more consumption constraints included in the pop request;
determining, by the producer computing device, one or more producer metrics usable by the consumer computing device to determine a subsequent action to be performed by the consumer computing device;
generating, by the producer computing device and in response to a determination the received pop request cannot be satisfied, a failure message that includes one or more of the producer metrics; and
transmitting, by the producer computing device, the failure message to the consumer computing device.

18. The method of claim 17, further comprising determining a present size of the producer work queue and a number of work elements presently in the producer work queue, and wherein determining the effective work availability comprises determining the effective work availability as a function of the present size of the producer work queue and the number of work elements presently in the producer work queue.

19. The method of claim 17, wherein determining the effective work availability comprises determining the effective work availability based on one or more rules of a work distribution rule set, wherein the one or more rules of the work distribution rule set define at least one of a minimum number of work elements to return per received pop request, a maximum number of work elements to return per received pop request, or a fraction of the work elements to return per received pop request.

20. The method of claim 17, wherein determining the producer metrics comprises determining at least one of data relative to the producer work queue at a point in time at which the pop request was received, historical data of the producer computing device to which the pop request was sent, or information corresponding to another producer computing device.

21. The method of claim 17, further comprising:
performing, by the producer computing device, a pop operation on each of the work elements of the producer work queue to be returned;
generating, by the producer computing device and in response to a determination the received pop request can be satisfied, a success message that includes the work elements of the producer work queue to be returned; and
transmitting, by the producer computing device, the success message to the consumer computing device and one or more of the producer metrics.

22. The method of claim 17, wherein identifying the one or more consumption constraints comprises identifying at least one of a size of the work elements of the producer work queue requested, an acceptable range of work elements of the producer work queue to receive, an upper threshold of work elements of the producer work queue to receive, a lower threshold of work elements of the producer work queue to receive, or a fraction of the work elements of the producer work queue to receive.

23. A producer computing device for dynamic work queue management, the producer computing device comprising:
a communication management circuit to receive a pop request from a consumer computing device, wherein the pop request includes one or more consumption constraints;
means for determining an effective work availability of a producer work queue of the producer computing device, wherein the producer work queue includes a plurality of work elements, wherein the effective work availability indicates a number of work elements of the producer work queue available to be stolen;
means for determining whether the received pop request can be satisfied based on the effective work availability and the one or more consumption constraints;
means for determining one or more producer metrics usable by the consumer computing device to determine a subsequent action to be performed by the consumer computing device; and
means for generating a failure message that includes one or more of the producer metrics,
wherein the communication management circuit is further to transmit the failure message to the consumer computing device.

24. The producer computing device of claim 23, further comprising a pop request response generation circuit to determine a present size of the producer work queue and a number of work elements presently in the producer work queue, and wherein the means for determining the effective work availability comprises means for determining the effective work availability as a function of the present size of the producer work queue and the number of work elements presently in the producer work queue.

25. The producer computing device of claim 23, wherein the means for determining the effective work availability comprises means for determining the effective work availability based on one or more rules of a work distribution rule set, wherein the one or more rules of the work distribution rule set define at least one of a minimum number of work elements to return per received pop request, a maximum number of work elements to return per received pop request, or a fraction of the work elements to return per received pop request.
